(19) United States
(12) Patent Application Publication
(10) Pub. No.: US 2026/0124720 A1
(43) Pub. Date: May 7, 2026

(54) COMPRESSION TOOL FOR APPLYING TERMINALS/SPLICES, ATTACHABLE TO IMPACT WRENCH

(71) Applicant: RESTART INDÚSTRIA, COMÉRCIO, IMPORTAÇÃO, EXPORTAÇÃO DE EQUIPAMENTOS E ACESSÓRIOS ELÉTRICOS LTDA., Porto Alegre (BR)

(72) Inventor: Andre Luis Muller da Silva, Porto Alegre (BR)

(73) Assignee: RESTART INDÚSTRIA, COMÉRCIO, IMPORTAÇÃO, EXPORTAÇÃO DE EQUIPAMENTOS E ACESSÓRIOS ELÉTRICOS LTDA., Porto Alegre (BR)

(21) Appl. No.: 18/983,998

(22) Filed: Dec. 17, 2024

(30) Foreign Application Priority Data
Nov. 6, 2024 (BR) 20 2024 023113 4

(51) Int. Cl. B25B 19/00; B25B 21/00

(52) U.S. Cl. CPC B25B 19/00; B25B 21/002

(57) ABSTRACT

The present utility model relates to a compression tool for applying terminals/splices attachable to an impact wrench, which, according to its characteristics, provides a compression tool (1) in its own and specific structure of universal type, attachable to an impact wrench and based on the integration of an applicator body (2), a lead screw (3) and a sliding compression die (4), so as to provide complete optimization in the set of mechanical and manual procedures for applying compression to terminals and splices of conductors of electric power distribution networks by using impact wrenches, combined with the absence of wear on conductors, terminals and splices and improvements in the maintenance of electric power distribution networks.

The present utility model belongs to applicator tools in general, and more specifically to a compression tool for applying terminals/splices attachable to an impact wrench which, according to its general characteristics, has as its basic principle to provide the formation of a compression tool in its own and specific structure of universal type, attachable to an impact wrench and based on the integration of an applicator body with a threaded hole, a lead screw and a sliding compression die, in order to allow, in an extremely practical, safe and precise way, a complete optimization in the set of mechanical and manual procedures for applying compression to terminals and splices of conductors of electric power distribution networks and other electric power networks by using impact wrenches, combined with the absence of wear and tear on conductors, terminals and splices and improvements in the maintenance of electric power distribution networks and, having as a basis, a compression tool with great strength, safety and versatility.

With a specific and easily accessible design and format for better adaptation and user safety, practical handling and functionality, very affordable and, due to its general characteristics and dimensions, easily adaptable to a wide range of terminals, splices, power conductors, impact wrenches, locations, and technicians in general, regardless of the characteristics they may present.

Currently, one of the main problems in the maintenance of low and medium-voltage power network branches are the electrical connections between the power cables/conductors, which are usually made by means of splices, as well as cable terminations which are made by means of terminals.

Electrical terminals and splices are components used to make reliable connections between conductors and other electrical system elements. They ensure the continuity of circuits and the safety and quality of electrical networks or installations. To meet the needs of companies and their technicians, as well as the most diverse types of projects, numerous models of electrical terminals are available.

In simple terms, an electrical terminal or splice is the component that connects a device or accessory to power conductors, and its main characteristic is its versatility since it is easily found in the most varied shapes and sizes. Therefore, electrical terminals can be defined as the components responsible for bridging two power conductors, which can be found in circuit breakers, meters, terminals, and relays, among others.

To understand how these components work, it is necessary to remember that these electrical components are made of electrically conductive material, such as electrolytic copper or aluminum, and the cable is usually fixed by compression. In such cases, a skived tip is inserted inside the terminal and then the tube where the cable is located is compressed using special pliers.

It should be noted that power conductors are considered essential components in any installation or equipment as they are the ones responsible for carrying electrical power from one point to another. Power conductors allow the safe and effective distribution of power, thus ensuring the supply of the electrical load in various situations.

Within this scenario, it is often necessary to expand the area of electrical power operation by splicing power conductors to ensure transmission to other points. This type of operation is so important that there is a regulatory standard that establishes all the conditions for splicing power conductors, so that splicing power conductors is the operation that consists in joining two or more conductors whose purpose is to extend or derive these same conductors.

Today, different models of tools for the installation and application of terminals and splices on power conductors adapted to truck hydraulics or manual or portable hydraulic pumps are widely known in the state of the art. Among these, some commercial solutions found in the market are presented, with the main manufacturers being Burndy, Greenlee, Huskie, Sanwa Tekki Co. Cembre.

More specifically, manual hydraulic tools for terminal presses—pliers, where the main difference is the price and the applicable maximum loads of the covered diameters, with Alimaq, Burndy and Ahb as the main manufacturers; hydraulic compression tools for terminal presses adaptable to fluid pumping systems that can be semi-automatic (manual fluid pumping) or automatic, using truck hydraulics or an external hydraulic pump system (an independent unit), with Burndy and Greenle as the main manufacturers; and automatic hydraulic tools for terminal presses, with Burndy and Alimaq as the main manufacturers; are widely known and used.

In an extensive review of the literature in order to provide the current state of the art of tools for applying compression to connectors, terminals and splices on power conductors, object of the present utility model, documents relevant to the prior art disclosing these types of tools were described, but none of them presents the same structural and operational concept as claimed by the present compression tool for applying both terminals and splices which is directly attachable to an impact wrench, as well as its portability (shape, dimensions and lightness) and load capacity (durability and integration).

However, although these devices are widely known and used by a wide range of technicians, they have the disadvantage of not being universally applicable to all the types of terminals, splices and conductors they cover, resulting in high tooling and maintenance costs, as well as complex and risky operation, especially since most of them are used in elevated and hard-to-reach places.

In this line of action, it has become essential for power utility companies and similar companies to structure a versatile, safe and precise tool capable of allowing the optimization of the procedures for applying compression to terminals and splices on power conductors in electrical networks, in the most varied locations, in order to increase the safety of technicians, reduce maintenance costs and improve the strength and durability of terminals and splices on power conductors, in addition to being universally applicable.

The present utility model is characterized by the combination of components and procedures in a differentiated design that meets the various requirements the nature of its use demands, that is, the application of terminals and splices using impact wrenches. The design ensures a compression tool of great efficiency, functionality, strength, durability, safety, versatility, precision, and ergonomics, thanks to the excellent added technical qualities that provide advantages and improvements in the procedures for applying terminals and splices to power conductors of electrical power distribution networks in general, and whose general characteristics differ from the other shapes and models widely known in the current state of the art.

More specifically, the general design of the present compression tool for applying terminals/splices attachable to an impact wrench, object of the present utility model, is based on an improvement introduced in the “Device for applying a wedge connector to a battery-operated impact wrench”, object of the utility model application BR 20 2021 010552 1, filed on May 21, 2021, and in the “Compression tool for applying terminals to a battery-operated impact wrench”, object of the utility model application BR 20 2021 025911 1, filed on Dec. 21, 2021, both from the same holder and inventor, aiming primarily at a better structure, applicability and operability of the set, these improvements having been introduced both in the applicator body, as well as in the lead screw and in the single block sliding die.

The present utility model comprises the use of a modern, efficient, safe and functional compression tool for applying terminals/splices attachable to an impact wrench formed by a set of properly incorporated mechanical and electrical solutions that form a complete and differentiated compression tool in its own and specific structure of universal type, and containing properly integrated and symmetrically arranged between them an applicator body as a structuring element of the compression tool, a lead screw as an element for transferring the driving force from the impact wrench to the compression die, and a compression die as a compression element for the conductors at the terminals/splices, so as to provide the formation of a complete and differentiated application tool in a single, complete and safe assembly, whose shapes and internal and external arrangements allow a seamless adaptation to a wide range of conductors, terminals, splices, impact wrenches, being specifically designed for these purposes.

More specifically, the general design of the present compression tool for applying terminals/splices attachable to an impact wrench, object of the present utility model, is based entirely on its simple and robust structure, with a minimum of components required, and its extremely simplified, safe and optimized applicability, combined with very practical manufacturing procedures, in order to obtain a practical and efficient compression tool of universal type, which can be attached to an impact wrench, so that terminals and splices can be applied to power conductors by using a sliding compression die internally coupled to the applicator body and directly engaged by the lead screw.

Considering these and other essential points, we have developed an improvement of a compression tool for applying terminals and splices to power conductors based on a tip that is coupled by its rear end to the front end of an impact wrench and that is directly responsible for its advancement, and incorporated by passing/threading the applicator body or applicator head that is directly responsible for supporting it and helping to engage a sliding compression die located inside the applicator body that acts directly on the terminal or splice of the conductor.

The present compression tool is based on the application of components and in a differentiated design without, however, reaching a high degree of sophistication and complexity, thus making it possible to solve some of the main drawbacks of other shapes and models known in the state of the art and used for applying terminals and splices to power conductors by using impact wrenches, which are located in an operating range in which the following are very common:
limitations in use and application, low efficiency and performance, accidents, high deterioration and fragility, low durability and strength, low versatility, high cost, generally high volume and weight, low ergonomic capacity, low flexibility and mobility, and low load-bearing capacity.

The objectives, advantages, and other important characteristics of the utility model in question can be more easily understood when read in conjunction with the accompanying drawings, in which:

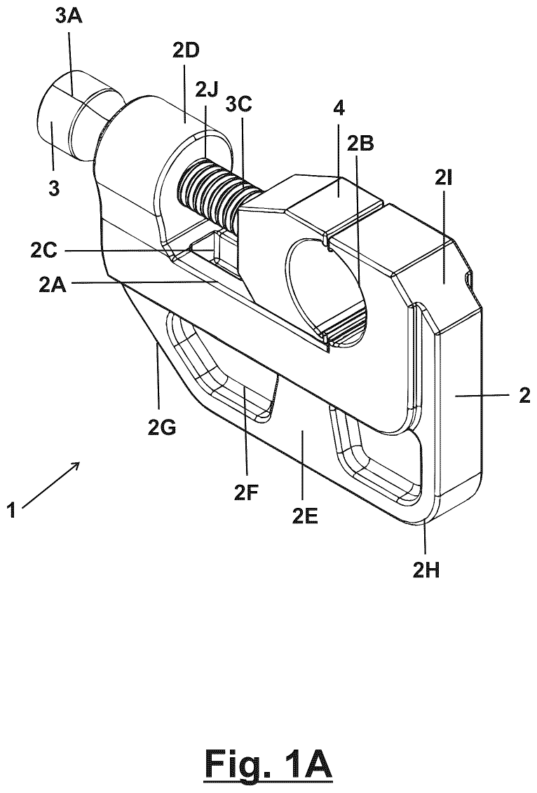

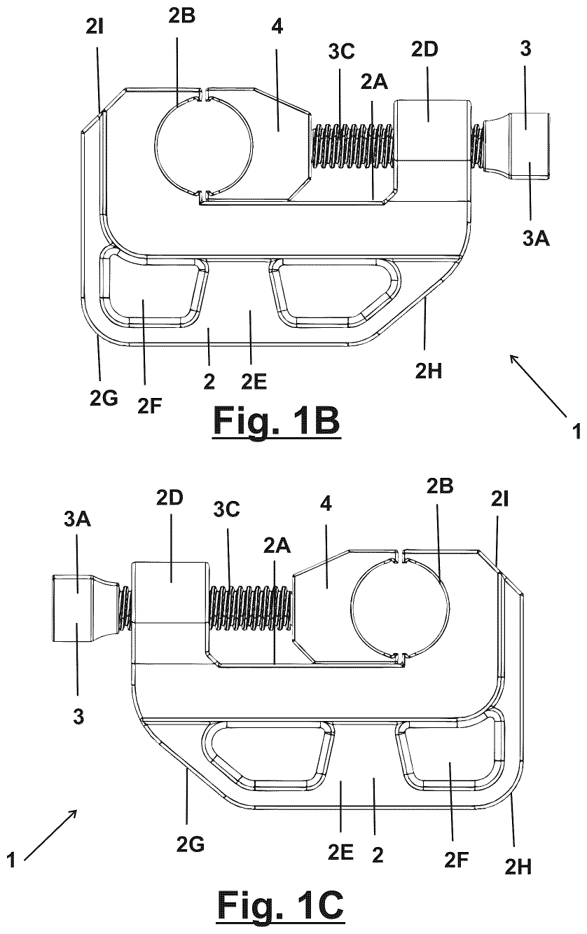

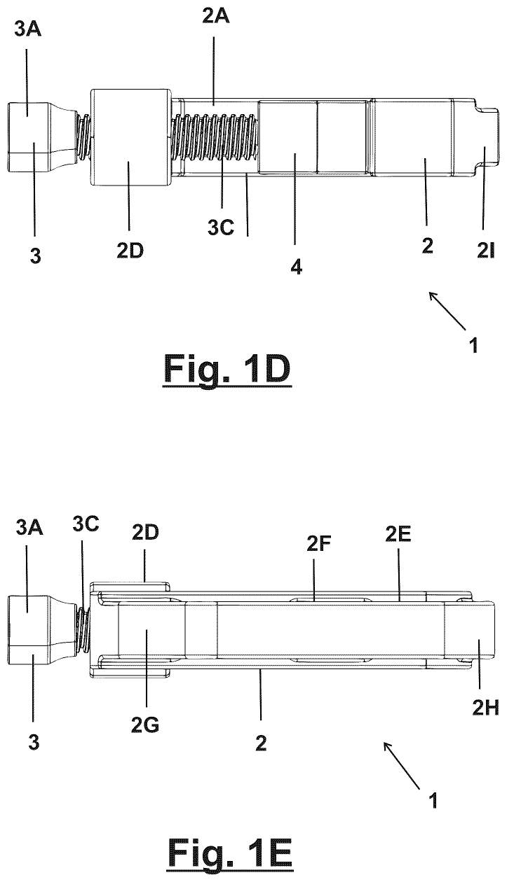

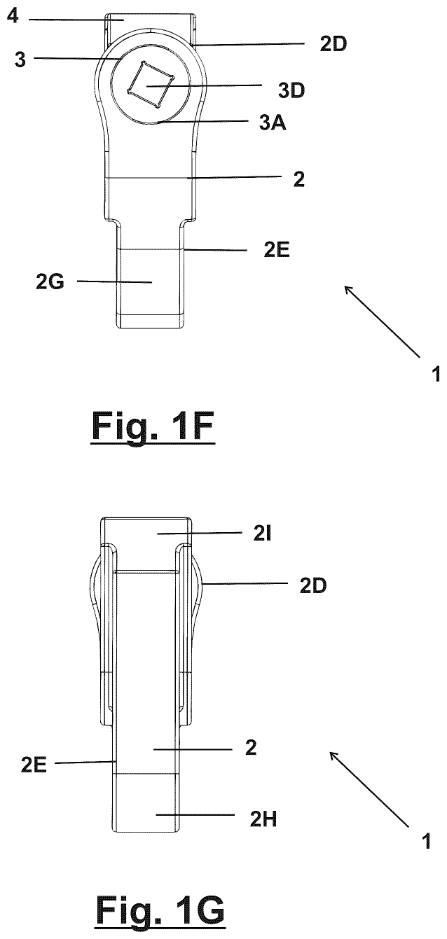

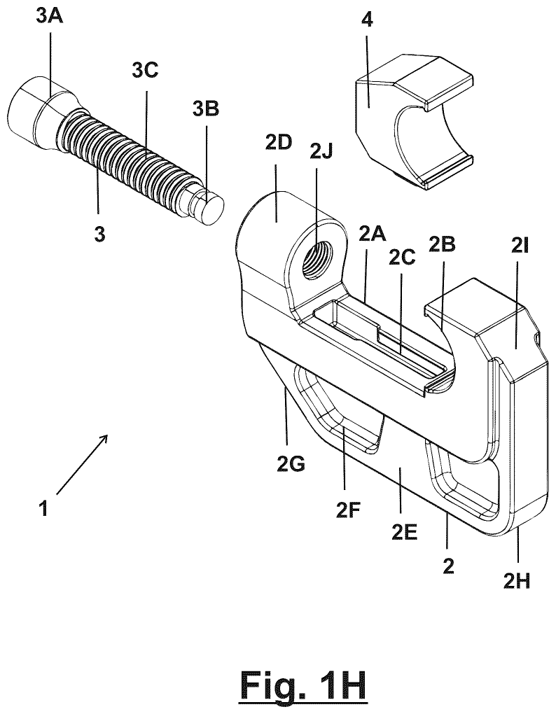

FIG. 1A is a perspective view of the compression tool for applying terminals/splices attachable to an impact wrench.

FIG. 1B is a left-side view of the compression tool for applying terminals/splices attachable to an impact wrench.

FIG. 1C is a right-side view of the compression tool for applying terminals/splices attachable to an impact wrench.

FIG. 1D is a top view of the compression tool for applying terminals/splices attachable to an impact wrench.

FIG. 1E is a bottom view of the compression tool for applying terminals/splices attachable to an impact wrench.

FIG. 1F is a rear view of the compression tool for applying terminals/splices attachable to an impact wrench.

FIG. 1G is a front view of the compression tool for applying terminals/splices attachable to an impact wrench.

FIG. 1H is an exploded perspective view of the compression tool for applying terminals/splices attachable to an impact wrench.

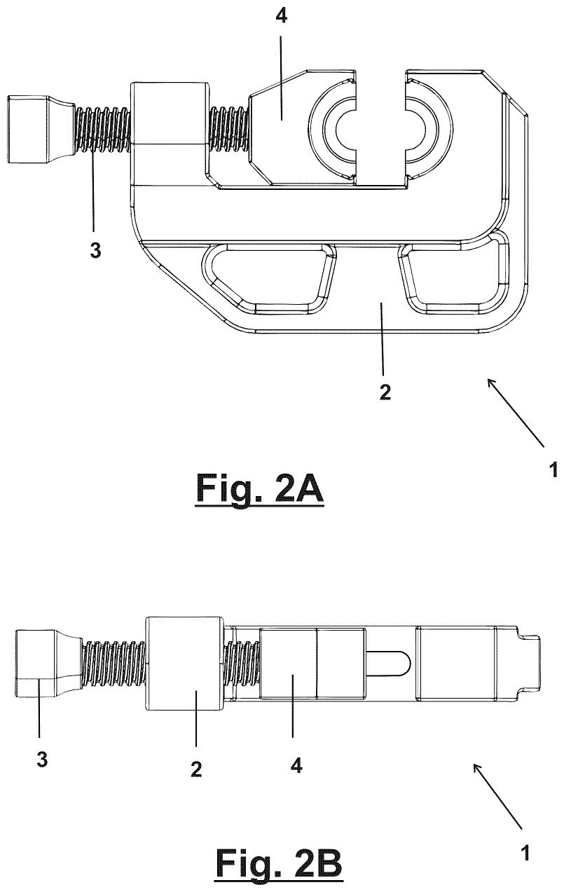

FIG. 2A is a right-side view of the compression tool for applying terminals/splices attachable to an impact wrench in an open arrangement.

FIG. 2B is a top view of the compression tool for applying terminals/splices attachable to an impact wrench in an open arrangement.

As shown from the accompanying drawings that illustrate and integrate the present descriptive report of the utility model “Compression Tool for Applying Terminals/Splices Attachable to an Impact Wrench”, FIG. 1A shows the compression tool in general comprising a compression tool (1) complete and with specific characteristics, incorporating its own mechanical structure of universal type, attachable to an impact wrench, with internal and external shapes and arrangements that adapt to a wide range of conductors, terminals and splices and containing properly integrated and symmetrically arranged between them:
an applicator body (2) in a U-shaped single block, arranged vertically and symmetrically along the entire length of the compression tool (1) and comprising a parallelepipedal top cutout (2A) arranged vertically, parallel and symmetrically centered along the top portion of the applicator body (2); a front recess (2B) concave and arranged vertically, parallelly and symmetrically along the entire length of the top of the applicator body (2) adjacent to the front face of the top cutout (2A); a bottom cutout (2C) parallelepipedal and arranged vertically, perpendicularly and symmetrically centered along the entire length of the upper part of the applicator body (2) adjacent to the bottom face of the top cutout (2A); a convex rear curvature (2D) arranged symmetrically around the superoposterior end of the top portion of the applicator body (2); a parallelepipedal bottom recess (2E) and arranged vertically, parallel and symmetrically along the entire length of the lateral surfaces of the rear and front portions of the applicator body (2); two parallelepipedal bottom openings (2F) arranged vertically, parallel and symmetrically aligned and spaced passing through the bottom portion of the applicator body (2); a rectilinear rear bevel (2G) arranged symmetrically along the entire length of the rear face of the bottom portion of the applicator body (2); a convex rear curvature (2H) arranged symmetrically around the bottom end of the bottom portion of the applicator body (2); a rectilinear front bevel (21) arranged symmetrically at the superoanterior end of the upper portion of the applicator body (2); and a cylindrical threaded hole (2J) arranged horizontally and symmetrically centered and passing through the rear block of the upper portion of the applicator body (2), subsequently aligning with the top cutout (2A);
a threaded cylindrical lead screw (3) in a single block and arranged horizontally and symmetrically along the upper portion of the applicator body (2) by means of its thread on the inside the threaded hole (2J) and comprised of a cylindrical rear head (3A) arranged horizontally, perpendicularly and symmetrically aligned and centered at the rear end of the lead screw (3); a cylindrical front tip (3B) arranged horizontally, perpendicularly and symmetrically aligned and centered at the rear end of the lead screw (3); a rear engagement (3C) with a square section of the built-in sock coupling type and arranged symmetrically centered along the inner portion of the rear head (3A) starting from the rear face of the rear head (3A); and a helical central thread (3D) arranged symmetrically along the entire length of the lead screw (3) between the rear head (3A) and the front tip (3B); and
A C-shaped compression die (4) arranged vertically, parallel and symmetrically sliding along the entire length of the inside of the top cutout (2A), fixed centered by its rear face at the front end of the front tip (3B) and aligned with its front face in the front recess (2B).

The compression tool for applying terminals/splices can also be provided with an impact wrench having a driving force generated by power from the mains, onboard batteries or even fully manual driving, both according to the needs required by the application.

The operation of the compression tool for applying terminals/splices attachable to an impact wrench is based on the correct coupling by threading the lead screw (4) into the applicator body (2) and subsequently, engaging the lead screw (4) into the impact wrench. The lead screw (4) is fitted directly into the threaded hole (3) using a thread between the parts, thereby fitting the lead screw (4) in the compression tool (1) and in the impact wrench by engaging the rear engagement (3C) on the impact wrench coupler thus transferring the driving force from the impact wrench to the compression tool (1).

The applicator body (2) is designed for the use of a compression die (4), so that the lead screw (3) is engaged by the rear engagement (3C) arranged at the rear end of the lead screw (3), so that the lead screw (3) runs through its threaded portion inside the threaded hole (2J), that is, the lead screw (3) advances over the applicator body (2)

[symbol]

The compression die (4) is supported and fitted symmetrically on the inside of the top cutout (2A), allowing it to slide perfectly when driven by the lead screw (3), that is, making approximation (compression) or separation (relief) about the front recess (2C) when acting directly on the conductor cables in need of terminals or splices.

The lead screw (3) moves until the compression die (4) is properly fitted and, subsequently, pushes the compression die (4) by sliding it into the applicator body (2) toward the front recess (2C), so as to keep the conductor cable between the compression die (4) and the front recess (2C).

The compression tool for applying terminals/splices attachable to an impact wrench is a versatile and indispensable solution for the various types of terminals and splices used on power conductors, as well as for low and medium voltage line technicians who use these components in the assembly and maintenance of power transmission lines. Its wide applicability and numerous advantages make this innovative compression tool (1) an exceptionally reliable choice with the primary objective of improving the final quality of transmission lines.

The compression tool for applying terminals/splices attachable to an impact wrench is an innovative solution that aims to improve the efficiency and final quality of terminals and splices applied to power conductors, fully protecting their integrity and, above all, the technicians, in view of the difficulties of use, safety, and efficiency of the current widely known tools, facilitating their handling at the application sites. Its robust construction, high-quality materials and compliance with current industry standards make it an exceptionally reliable choice.

Specifically, the test results show that the compression tool for applying terminals/splices attachable to an impact wrench provides even better results than the other tools available on the market, as well as a great financial advantage by replacing electro-hydraulic tools due to their high cost, and better ergonomics for the operator in the case of using manual hydraulic pliers that require great physical effort, in addition to contributing directly to the environment by not generating waste, especially of hydraulic oil after its use.

As the compression tool for applying terminals/splices attachable to an impact wrench has fully integrated components, they can be assembled and disassembled quickly, with nothing coming loose or breaking off, thus achieving high performance and efficiency, combined with high durability and complete safety during use. Once fully integrated with each other and with the impact wrench, the components are completely locked and united, thus preventing them from loosening during use, making the set fully available for applying terminals and splices to conductor cables in electrical power distribution networks and other electrical networks. The compression tool (1) can therefore be used without any worries, especially with regard to the safety and durability of its components and the safety of its users—electric power company technicians.

In view of the foregoing, the present manual tool will be well received by power utility technicians who need to apply terminals and splices to conductor cables in general, since the compression tool for applying terminals/splices attachable to an impact wrench offers several advantages, such as: great safety, reliability and flexibility in its use; great efficiency and performance in its use due to its general design; high comfort, convenience and safety for power utility technicians; great overall strength and durability; combined with little or no wear on the set as a whole; fully accessible cost, providing an excellent cost/benefit ratio; practical and safe use by any utility technician; long working range; perfect and direct adaptation to the most varied types of terminals and splices for conductor cables; great mobility and flexibility of the set; high ergonomics and the certainty of having a compression tool (1) that fully complies with the current rules and regulations required for its use.

All such attributes classify the compression tool for applying terminals/splices attachable to an impact wrench as a fully versatile, efficient, practical, and safe means for manual application procedures of a wide variety of terminals and splices to the various different types of power conductors, using various different types of impact wrenches and various locations, regardless of the desired general characteristics, not being in any way limited to the specific embodiments described herein, but being intended to encompass variations and modifications within the scope of protection thereof as defined by the attached claims.

1. “COMPRESSION TOOL FOR APPLYING TERMINALS/SPLICES ATTACHABLE TO AN IMPACT WRENCH”, characterized in that it comprises a mechanical structure of universal type attachable to an impact wrench and containing integrated and symmetrically arranged between them:
an applicator body (2) in a U-shaped single block, arranged vertically and symmetrically along the entire length of the compressor tool (1) and comprising a parallelepipedal top cutout (2A) arranged vertically, parallel and symmetrically centered along the top portion of the applicator body (2); a front recess (2B) concave and arranged vertically, parallel and symmetrically along the entire length of the top of the applicator body (2) adjacent to the front face of the top cutout (2A); a bottom cutout (2C) parallelepipedal and arranged vertically, perpendicularly and symmetrically centered along the entire length of the Upper part of the applicator body (2) adjacent to the bottom face of the top cutout (2A); a convex rear curvature (2D) arranged symmetrically around the superoposterior end of the top portion of the applicator body (2); a parallelepipedal bottom recess (2E) arranged vertically, parallel and symmetrically along the entire length of the lateral surfaces of the rear and front portions of the applicator body (2); two parallelepipedal bottom openings (2F) arranged vertically, parallel and symmetrically aligned and spaced passing through the bottom portion of the applicator body (2); a rectilinear rear bevel (2G) arranged symmetrically along the entire length of the rear face of the bottom portion of the applicator body (2); a convex rear curvature (2H) arranged symmetrically around the bottom end of the bottom portion of the applicator body (2); a rectilinear front bevel (21) arranged symmetrically at the superoanterior end of the upper portion of the applicator body (2); and a cylindrical threaded hole (2J) arranged horizontally and symmetrically centered and passing through the rear block of the upper portion of the applicator body (2), subsequently aligning with the top cutout (2A);
a threaded cylindrical lead screw (3) in a single block and arranged horizontally and symmetrically along the upper portion of the applicator body (2) by means of its thread on the inside the threaded hole (2J) and comprised of a cylindrical rear head (3A) arranged horizontally, perpendicularly and symmetrically aligned and centered at the rear end of the lead screw (3); a cylindrical front tip (3B) arranged horizontally, perpendicularly and symmetrically aligned and centered at the rear end of the lead screw (3); a rear engagement (3C) with a square section of the built-in sock coupling type and arranged symmetrically centered along the inner portion of the rear head (3A) starting from the rear face of the rear head (3A); and a helical central thread (3D) arranged symmetrically along the entire length of the lead screw (3) between the rear head (3A) and the front tip (3B); and
A C-shaped compression die (4) arranged vertically, parallel and symmetrically sliding along the entire length of the inside of the top cutout (2A), fixed centered by its rear face at the front end of the front tip (3B) and aligned with its front face in the front recess (2B).
